(19) United States
(12) Patent Application Publication
(10) Pub. No.: US 2007/0003036 A1
(43) Pub. Date: Jan. 4, 2007

(54) Identifying a caller who uses an unrecognized terminal

(75) Inventors: Fonda J. Daniels, Cary, NC (US); Timothy Earl Figgins, Raleigh, NC (US); Wesley Jerome Gyure, Wake Forest, NC (US); Kent Fillmore Hayes JR., Chapel Hill, NC (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, ARMONK, NY (US)

(21) Appl. No.: 11/168,251

(22) Filed: Jun. 28, 2005

(51) Int. Cl. H04M 15/06

(52) U.S. Cl. 379/142.01

(57) ABSTRACT

Methods, apparatus, computer program instructions and products, and services for identifying, to a called party, a calling party who uses a terminal that would otherwise be unrecognized by the called party, such as a borrowed cellphone. According to one aspect of the invention, a service provider receives set-up information from a calling party bearing a first caller ID number; determines a second caller ID number associated with the calling party, where the first caller ID number and the second caller ID number are not the same; and initiates connection of the calling party and the called party, using the second caller ID number to identify the calling party to the called party.

### BACKGROUND

The present invention concerns the field of telecommunications, and more particularly concerns identifying a party who calls using an unrecognized terminal such as a borrowed cellular telephone.

The proliferation of modern telecommunication services can be a mixed blessing. Despite the overwhelmingly positive benefits that terminals such as cellular telephones provide, users of such devices are sometimes bothered by unwanted traffic. As a consequence, various call-screening methods have arisen.

For example, a user may load a list of telephone numbers into a cellular telephone's internal phonebook. Each telephone number may be paired with a signature item, such as a digitized photograph of a person. When a call comes in, the terminal searches the phonebook, in an attempt to match the incoming caller ID. If the incoming caller ID matches an entry in the phonebook, the terminal presents the signature item to the user. For example, a parent might load his or her child's cellular telephone number and digitized photograph into the phonebook, so that when the child calls the parent, the child's picture pops up, and parent can identify the incoming call as being from the child. If, conversely, the caller ID of the incoming call is not found in the terminal's internal phonebook, a signature item such as a photograph is not displayed to the user. Rather, the user may see only the caller ID number itself.

Thus, the user is enabled to screen incoming calls. Pictures of people he or she especially wants to talk with, or pictures of people he or she especially wants to avoid, pop up as their calls come in, whereas others are announced only by their caller ID numbers.

A problem arises, however, when someone the user wants to talk with calls the user from a terminal that is not registered in the user's telephone book. Here, such a terminal is called an “unrecognized terminal.” For example, a child might borrow someone else's cellular telephone, because the battery has died in the child's own cellular telephone. If the child then calls the parent using the borrowed cellphone, the parent's cellphone cannot show the child's picture, as the incoming caller ID number of the borrowed cellphone is unknown to the parent's phonebook. As a consequence, the parent might unintentionally decline to answer the call.

### SUMMARY

The invention includes methods, apparatus, computer program instructions and products, and services for identifying, to a called party, a calling party who uses a terminal that would otherwise not be recognized by the called party terminal, such as a borrowed cellphone.

According to one aspect of the invention, a service provider receives set-up information from a calling party bearing a first caller ID number; determines a second caller ID number associated with the calling party, where the first caller ID number and the second caller ID number are not the same; and initiates connection of the calling party and the called party, using the second caller ID number to identify the calling party to the called party.

Another aspect of the invention includes a method for identifying a calling party. The method comprises receiving set-up information from a calling party having a first caller ID number; determining a second caller ID number associated with the calling party using set-up information that identifies the calling party, which second caller ID number is not the same as the first caller ID number; and initiating connection of the calling party and the called party, using the second caller ID number to identify the calling party to the called party.

### BRIEF DESCRIPTION OF THE SEVERAL VIEWS OF THE DRAWINGS

FIG. 1 is a block diagram that shows a network-interconnected calling party, called party, and identification service provider.

FIG. 2 is a flowchart that shows aspects of a method for identifying a calling party who uses an unrecognized terminal.

### DETAILED DESCRIPTION

The present invention will now be described more fully hereinafter, with reference to the accompanying drawings, in which illustrative embodiments of the invention are shown. Throughout the drawings, like numbers refer to like elements.

The invention may, however, be embodied in many different forms, and should not be construed as limited to the embodiments set forth herein; rather, these embodiments are provided so that the disclosure will be thorough and complete, and will fully convey the scope of the invention to those skilled in the art.

As will be appreciated by one of skill in the art, the present invention may be embodied as a method, data processing system, service, or computer program instructions or product. Accordingly, the present invention may take the form of an embodiment entirely in hardware, entirely in software, or in a combination of aspects in hardware and software referred to as circuits and modules.

Furthermore, the present invention may take the form of a computer program product on a computer-usable storage medium having computer-usable program code embodied in the medium. Any suitable computer-readable medium may be utilized, including hard disks, CD-ROMs, optical storage devices, magnetic storage devices, and transmission media such as those supporting the Internet or an intranet.

Computer program code for carrying out operations of the present invention may be written in an object oriented programming language such as Java7, Smalltalk, or C++. However, the computer program code for carrying out operations of the present invention may also be written in conventional procedural programming languages, such as the C programming language. The program code may execute entirely on the user's computer, partly on the user's computer, as a stand-alone software package, partly on the user's computer and partly on a remote computer, or entirely on a remote computer. The remote computer may be connected to the user's computer through a local area network or a wide area network, or the connection may be made to an external computer, for example through the Internet using an Internet Service Provider.

The present invention is described below with reference to flowchart illustrations and/or block diagrams of methods, apparatus (systems), and computer program products according to embodiments of the invention. It will be understood that each block of the flowchart illustrations and/or block diagrams can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions and/or acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the functions or acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions and/or acts specified in the flowchart and/or block diagram block or blocks.

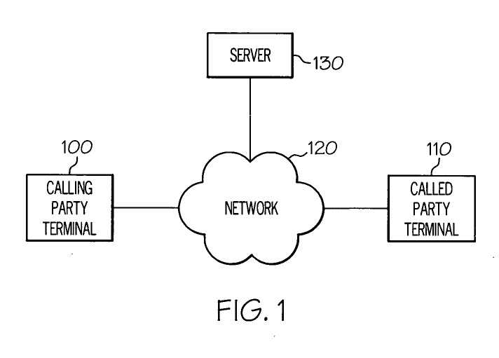

FIG. 1 shows a calling party terminal 100, and a called party terminal 110, which may communicate with each other over a network 120. For descriptive clarity, the discussion that follows uses examples wherein the calling party terminal 100 and the called party terminal 110 are mobile telephones such as cellular telephones or cellphones. In such examples, the network 120 may be a wireless network such as a cellular telephone network provided by a communication common carrier, or may be the larger public telephone network, which may include various wireline and wireless segments.

It is important to note, however, that the invention is not limited to these kinds of terminals and networks. The terminals may be, for example, any kind of communication terminal such as a laptop computer or personal digital assistant with integrated telephone support, or may be wireline or terrestrial telephone terminals. Moreover, the network 120 may be, for example, a wireless network, a satellite network, a terrestrial wireline network, or any combination of these kinds of networks; may be public or private; and may be the Internet or an intranet; and the like.

As shown in FIG. 1, a server 130 may be connected to the network 120. In this example, one purpose of the server 130 is to provide an identification service that identifies the calling party to the called party terminal 110, when the calling party would not otherwise be recognized by the called party terminal 110, as described below. Here, the calling party is the party who uses the calling party terminal 100, and the called party is the party who uses the called party terminal 110.

The called party may load telephone numbers into memory such as an internal phonebook of the called party terminal 110. These telephone numbers may be paired with signature items, such as digitized photographs of potential callers. For each incoming call, the called party terminal 110 searches the memory in an attempt to match the incoming caller ID number. If the incoming caller ID number matches an entry in the memory, the called party terminal 110 presents the signature item such as a photograph to the called party. If, conversely, the caller ID number of the incoming call is not found in the terminal's internal phonebook, a signature item is not presented to the user. Thus, the user is enabled to screen incoming calls.

For example, a parent might load his or her child's cellular telephone number and digitized photograph into the phonebook. The parent can then see the displayed picture when the child calls, and thereby identify an incoming call as being from the child. The signature item is not limited to a digitized photograph, however, and may be any convenient way to identify a caller, including, for example, the caller's name, a graphic such as a cartoon character or Zodiac symbol that the called party wishes to associate with a caller, a distinctive ring tone associated with a caller, and the like.

A problem arises, however, when a calling party uses a terminal that is not registered in the memory of the called party terminal. Here, such a calling party terminal is known as an “unrecognized terminal.” For example, a child might call the parent using a borrowed cellphone. In this case, the parent's cellphone cannot show the child's picture, as the incoming caller ID number is unknown to the parent's phonebook.

To remedy this situation, the server 130 may provide an identification service that identifies the calling party to the called party terminal 110, when the calling party terminal 100 would otherwise be unrecognized by the called party terminal 110, or would otherwise be incorrectly recognized. The ID service may be subscribed to by the calling party, and may be provided by a communication common carrier that also provides a communication service via the network 120, although the invention is not limited to this situation. For example, the identification service may be provided by a cellular telephone common carrier that also provides cellular telephone service to the calling party, as an option of the calling party's cellular service plan.

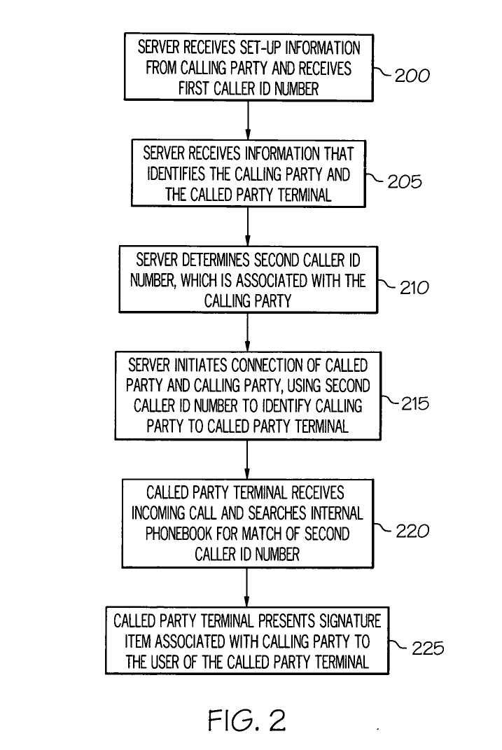

FIG. 2 is a flowchart that shows aspects of a method for identifying a calling party who uses a terminal that would otherwise be unrecognized by the called party terminal 110.

Using the calling party terminal 100, the calling party provides set-up information received by the server 130 (block 200). The server 130 may receive a first caller ID number, which may be the caller ID number of the calling party terminal 100. However, the first caller ID number may not be useful in identifying the calling party when the calling party uses a calling party terminal 100 that is unknown, or incorrectly known, to the called party terminal 110, as may be the case when, for example, the calling party borrows a cellphone from someone else. Throughout, the expression “caller ID number” is used for descriptive convenience. This term should be interpreted broadly, and is intended to include any information that flows as part of the caller ID process, not just the number itself.

The server 130 receives information from the calling party that specifies the called party terminal 110 and identifies the calling party (block 205). The information that specifies the called party terminal 110 may be the called party's telephone number, or any other preestablished label. The information that identifies the calling party may be a service account number or a telephone number associated with the calling party, or the like. A pass code or personal identification number (PIN) may be used to identify the calling party, or to discourage spoofing or fraudulent use of the identification service.

Using the information that identifies the calling party, the server 130 determines a second caller ID number that has been preassociated with the calling party and held in memory by the server 130 (block 210). For example, the second caller ID number may be held in memory by the server 130 in association with the account number of the calling party, and may be the telephone number of a cellular service subscription normally used by the calling party.

The server initiates connection of the calling party terminal 100 and the called party terminal 110 (block 215), using the second caller ID number to identify the calling party to the called party terminal 110. So, in effect, the server 130 intercepts the call from the calling party terminal 100 to the called party terminal 110, and replaces the first caller ID number, which may be the caller ID number of a borrowed cellphone, with the second caller ID number, which may be the caller ID number of the cellphone normally used by the calling party.

The called party terminal 110 receives the incoming call (block 220), and searches its memory for the incoming caller ID number, which is now the second caller ID number. Because the second caller ID number has replaced the first caller ID number, the called party terminal correctly identifies the calling party, and finds the appropriate signature item. The called party terminal 110 then presents the calling party's signature item to the called party (block 225), for example by displaying a digitized photograph of the calling party.

Although the foregoing has described systems, methods, services, and computer program instructions and program products for identifying a caller, the description of the invention is illustrative rather than limiting; the invention is limited only by the claims that follow.

We claim:

1. A method for providing an identification service, comprising:
receiving set-up information from a calling party bearing a first caller ID number;
determining a second caller ID number associated with the calling party, using at least part of the set-up information, where the first caller ID number and the second caller ID number are not the same; and
initiating connection of the calling party and the called party, using the second caller ID number to identify the calling party to the called party.

2. The method of claim 1, wherein the second caller ID number is a caller ID number of a communication common carrier service account subscribed to by the calling party.

3. The method of claim 2, wherein the communication common carrier service is cellular telephone service.

4. The method of claim 2, wherein the communication common carrier provides the identification service.

5. The method of claim 2, wherein the communication common carrier provides telecommunication service that connects the calling party and the called party.

6. The method of claim 1, wherein the calling party provides the second caller ID number as part of the set-up information.

7. The method of claim 1, wherein the set-up information includes an account number that identifies the calling party, which account number is used in determining the second caller ID number.

8. The method of claim 1, wherein the set-up information includes a PIN that identifies the calling party, which PIN is used in determining the second caller ID number.

9. A method for identifying a calling party, comprising:
receiving set-up information from a calling party bearing a first caller ID number;
determining a second caller ID number associated with the calling party, using at least part of the set-up information, where the first caller ID number and the second caller ID number are not the same; and
initiating connection of the calling party and the called party, using the second caller ID number to identify the calling party to the called party.

10. The method of claim 9, wherein the calling party provides the second caller ID number as part of the set-up information.

11. The method of claim 9, wherein the set-up information includes an account number that identifies the calling party, which account number is used in determining the second caller ID number.

12. The method of claim 9, wherein the set-up information includes a PIN that identifies the calling party, which PIN is used in determining the second caller ID number.

13. A computer program product for identifying a calling party, the computer program product comprising a computer readable medium having computer readable program code embedded therein, the computer readable program code comprising:
computer readable program code configured to receive set-up information from a calling party bearing a first caller ID number;
computer readable program code configured to determine a second caller ID number associated with the calling party, using at least part of the set-up information, where the first caller ID number and the second caller ID number are not the same; and
computer readable program code configured to initiate connection of the calling party and the called party, using the second caller ID number to identify the calling party to the called party.

14. The computer program product of claim 13, wherein the calling party provides the second caller ID number as part of the set-up information.

15. The computer program product of claim 13, wherein set-up information includes an account number that identifies the calling party, which account number is used in determining the second caller ID number.

16. The computer program product of claim 13, wherein the set-up information includes a PIN that identifies the calling party, which PIN is used in determining the second caller ID number.
